(19) United States
(12) Patent Application Publication
(10) Pub. No.: US 2008/0080708 A1
(43) Pub. Date: Apr. 3, 2008

(54) Key wrapping system and method using encryption

(76) Inventors: Donald Kent McAlister, Apex, NC (US); Marcelle Gibble, Raleigh, NC (US)

Correspondence Address: TRIANGLE PATENTS, P.L.L.C., P.O. BOX 28539, RALEIGH, NC, 27611-8539, US

(21) Appl. No.: 11/529,819

(22) Filed: Sep. 29, 2006

(51) Int. Cl. H04L 9/00

(52) U.S. Cl. 380/44

(57) ABSTRACT

A method for enabling secure communication between a first node in a distributed network and at least one second node in the distributed network by using a cryptographic key, including the steps of using an encrypting key to encrypt the cryptographic key to generate a wrap key in a secure hardware module, transmitting the wrap key to the at least one second node over a network, and decrypting the wrap key using the encrypting key to obtain the cryptographic key. Also, a system for enabling secure communication in a distributed network by using a cryptographic key, including a first node transmitting the cryptographic key, a secure hardware module for encrypting the cryptographic key with a encrypting key to obtain a wrap key, a network for transmitting the wrap key, and a second node, the second node configured to decrypt the wrap key using the encrypting key to obtain the cryptographic key.

### BACKGROUND OF THE INVENTION

1. Field of the Invention

The present invention relates generally to key protection. Further, the present invention relates to a secure hardware key protection device for use in a secure distributed network.

2. Description of the Prior Art

Key encryption techniques are widely used to authenticating and encrypting messages between parties over an insecure media. By encrypting messages with keys, only parties that have knowledge of the key can decrypt the messages. However, if the keys that are used for encrypting the messages are compromised, then the message is no longer protected. Someone, other than the sender or receiver, who has access to the keys, can change an encrypted message without the knowledge of the sender or receiver.

There are solutions that address the problem of protecting the keys from attackers. Some of these solutions involve use of algorithms that ensure that the messages have not been changed and they are from the original senders. Another set of solutions is designed to detect when the keys have been stolen. If the keys are stolen, then the senders and receivers that use the key are notified and they can change the key that they use for communication.

Some solutions involve protecting the keys from being stolen. One such solution is disclosed in U.S. Pat. No. 5,237,611 titled “Encryption/decryption apparatus with non-accessible table of keys” by Rasmussen, et. al. Another solution is described by Buer in US Patent Publication No. 20060072762 titled “Stateless hardware security module”. These solutions discuss a hardware module that generates keys and provide security to the generated keys.

Though there exist solutions that use secure hardware devices that protect generated keys and transmit the keys so that they are not accessible to attackers, there are no solutions that discuss the use of hardware devices that are protected from attackers that may access the memory contents of the device itself to access the generated keys. Further, there are no solutions that discuss use of hardware devices to securely encrypt cryptographic keys, while preventing the cryptographic keys from being accessed by attackers.

Therefore, there is a need for a solution that will independently encrypt keys before transmission. The solution should be able to withstand attacks and should be able to protect the original key from being accessed by attackers. Further, this solution should be able to generate and distribute keys in a distributed network where the same key is sent to many recipients.

### SUMMARY OF THE INVENTION

A first aspect of the present invention is to provide a method for enabling secure communication between a first node in a distributed network and at least one second node in the distributed network by using a cryptographic key, comprising the steps of using an encrypting key to encrypt the cryptographic key to generate a wrap key in a secure hardware module, transmitting the wrap key to the at least one second node over a network, and decrypting the wrap key using the encrypting key to obtain the cryptographic key.

A second aspect of the present invention is to provide a system for enabling secure communication in a distributed network by using a cryptographic key, comprising a first node transmitting the cryptographic key, a secure hardware module for encrypting the cryptographic key with a encrypting key to obtain a wrap key, a network for transmitting the wrap key, and a second node, the second node configured to decrypt the wrap key using the encrypting key to obtain the cryptographic key.

Another aspect of the present invention is to provide a secure hardware module for enabling secure communication in a distributed network using a cryptographic key, comprising a cryptographic key generation module for generating a cryptographic key, a wrap key generation module for encrypting the cryptographic key with a encrypting key to obtain a wrap key, a storage module for storing the cryptographic key, and a key protection module for protecting the cryptographic key from being accessed and for disabling the secure hardware module when tampered.

The present invention is further directed to a method for protecting cryptographic keys from being stolen or accessed in the memory of the hardware module in which they are generated before they are encrypted.

Thus, the present invention provides a system for encrypting or wrapping cryptographic keys to securely transmit the keys over unsecured networks.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 is a schematic of the overall system, in accordance with an embodiment of the present invention.

FIG. 2 is a schematic depicting an exemplary key authority point and a policy enforcement point, in accordance with an embodiment of the present invention.

FIG. 3 is a schematic of a secure hardware module, in accordance with an embodiment of the present invention.

FIG. 4 is a flowchart depicting the method of generating a key and sending the key to policy enforcement points, in accordance with an embodiment of the present invention.

FIG. 5 is a flowchart depicting the method of protecting the secure hardware module, in accordance with an embodiment of the present invention.

### DETAILED DESCRIPTION

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms.

The present invention provides a method and a system for securing communication between two or more nodes in a distributed network. A distributed network comprises multiple nodes that are interconnected by multiple routers, bridges, and in different network topologies. In a distributed network, a node may be part of a smaller network such as an office LAN, or even a single node directly connected to the internet. The node can be connected to an unprotected network such as the internet either directly or through a gateway, router, firewall and other such devices that allow one or more nodes to connect to a network via a single point. The nodes can be computing devices such as laptops, desktops, handheld devices, mobile devices, cable access systems, and other devices capable of connecting to a network, or a network or such devices.

These nodes communicate with each other, or servers providing services such as web pages, email, voice over IP, video broadcasting, multicasting applications, streaming audio or video via unprotected networks. In certain cases, when the communication is between two nodes that are using the same network, this communication may be protected. However, most of the communication over the internet is unprotected. This means that the communication can be intercepted by anyone. This communication is protected by using cryptographic keys. One or more nodes are grouped together so that they communicate over the unprotected networks via a policy enforcement point (PEP). There are several such PEPs in the distributed network. The PEPs receives policies from a management and policy server (MAP). The MAP defines the policies that govern the communication of the PEPs and the nodes under the PEPs. There are one or more key authority points (KAP) that communicate with the MAP and generate cryptographic keys for PEPs. There are several configurations that are possible for arranging PEPs and KAPs. There may be multiple KAPs for one or more PEPs. There may be a single KAP for all the PEPs in a distributed network.

Based on the policies received from the MAP, the Key Authority Point (KAP) generates cryptographic keys for each of the Policy Enforcement Points (PEPs) within its network as defined by the MAP. The PEPs use the cryptographic keys to encrypt communication from the nodes and networks that they protect to unprotected networks, decrypt communication from unprotected networks to the nodes and networks that they protect or both. All KAPs receive the policy definition from a single MAP. This policy definition informs the KAP which PEP it is responsible for, which networks the PEPs protect, and which KAP units they use. The KAP distributes the keys and policies associated with its networks and nodes to the appropriate PEPs.

The KAPs send cryptographic keys to the PEPs. These keys are encrypted at the KAP with an encrypting key. The encrypting key is a pre-shared private key. The KAPs have a secure hardware module that stores the pre-shared private key and encrypts the cryptographic keys. The secure hardware module is tamper proof and disables access if the KAP is attacked. The use of the secure hardware module prevents exposure of the cryptographic keys in memory or backplane, where they can be accessed in clear text. The secure hardware module's tamper proof feature enables it to shut down when it detects that it has been removed from the KAP. Hence, during attack, the cryptographic keys cannot be accessed, since they are stored in the secure hardware module which shuts down when it detects attack. Attack can be in the form of removal of the secure hardware module so that its memory can be independently accessed to gain access to the cryptographic key.

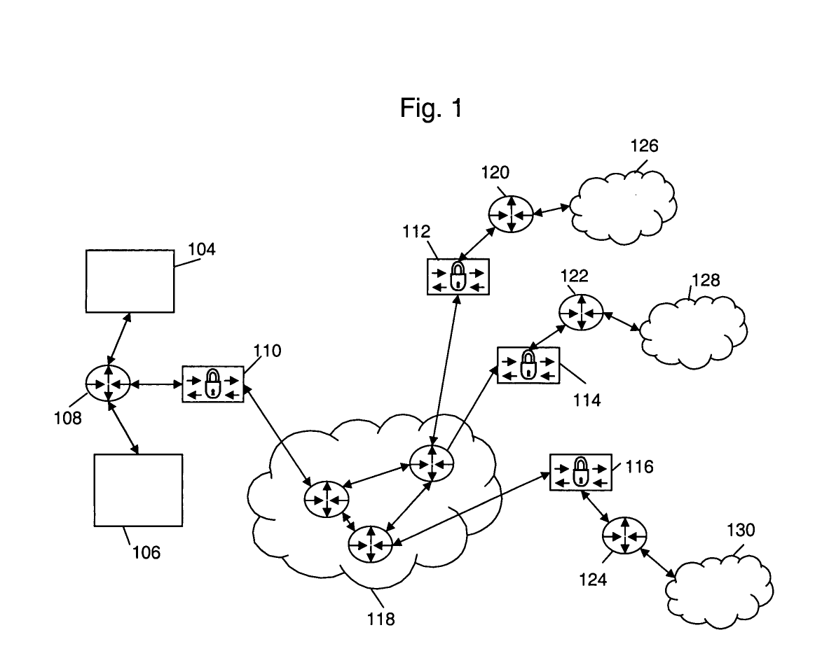

Referring now to the drawings in general, the illustrations are for the purpose of describing a preferred embodiment of the invention and are not intended to limit the invention thereto. As best seen in FIG. 1, a schematic of the overall system, in accordance with an embodiment of the present invention is shown. A management and policy (MAP) server 104 and a key authority point (KAP) 106 are connected to a network node 108. Network node 108 connects to a policy enforcement point (PEP) 110. PEPs 112, 114 and 116 are also connected to PEP 110 via an unprotected network 118. Unprotected network 118 is a network of interconnected nodes and smaller networks, such as the internet or a local LAN or WAN. PEPs 112, 114 and 118 are connected to network nodes 120, 122 and 124 respectively. The network nodes may be individual network points or can be access points to sub-networks 126, 128 and 130. KAP 106 generates and sends keys to PEPs 110, 112, 114 and 116. The keys enable PEPs to encrypt and/or authorize communication between the PEPs 110, 112, 114 and 118 and the nodes behind the PEPs. In an alternate embodiment, MAP 104 and KAP 106 are implemented as programs that reside on network node 108.

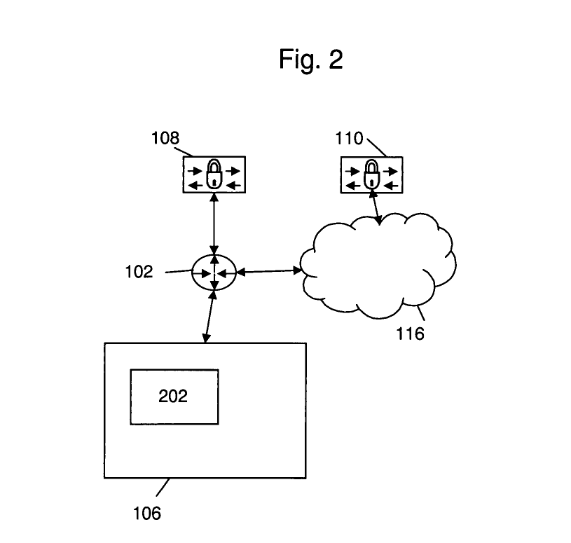

FIG. 2 is a schematic depicting an exemplary key authority point and a policy enforcement point, in accordance with an embodiment of the present invention. A secure hardware module 202 is connected to KAP 106. The secure hardware module 202 is physically attached to the same computer or hardware on which the KAP 106 is implemented. In one embodiment, KAP 106 is implemented as a computer implemented code on a computing device. In this case, secure hardware module 202 is connected to the same computing device on which KAP 106 is implemented. In an alternate embodiment, KAP 106 is implemented as a hardware device. In this case, secure hardware module 202 is implemented as a hardware device that is connected to the KAP hardware device. The means of connecting secure hardware module 202 to KAP 106 are known in the art and are omitted from this application for the sake of conciseness, as will be apparent to one skilled in the art.

Secure hardware module 202 generates a cryptographic key, encrypts that key with an encryption key such as a pre-shared private key to obtain a wrap key. The wrap key is then transmitted with KAP 106 to PEPs 108 and 110. The encrypting key is pre-shared with PEPs through alternate means of communication. The PEPs can use the same key to decrypt the wrap key, thus obtaining the cryptographic key that is used by the PEPs to encrypt communication. In an alternate embodiment, secure hardware module 202 uses a public key that is part of a private-public key pair as the encrypting key to generate the wrap key. PEPs then use the private key of the pair to decrypt the wrap key.

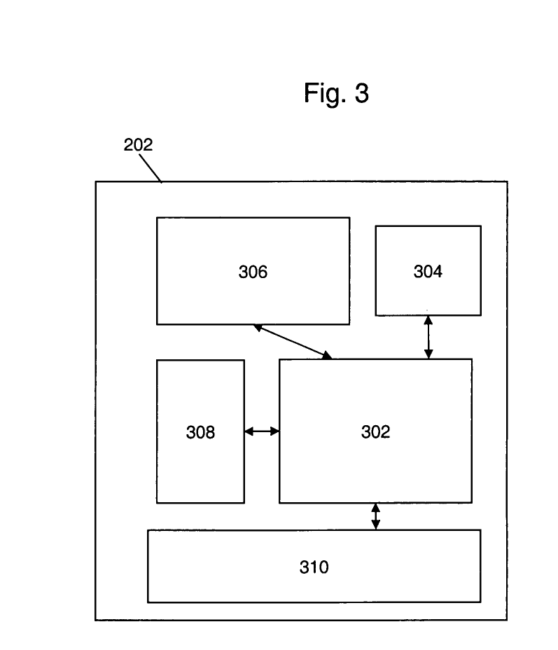

FIG. 3 is a schematic of a secure hardware module, in accordance with an embodiment of the present invention. FIG. 3 shows processor 302, memory 304, storage 306, communication module 308 and key protection module 310. Processor 302 is coupled with memory 304, storage module 306, communication module 308 and key protection module 310. Processor 302 implements modules for cryptographic key generation and wrap key generation. Processor 302 generates a cryptographic key by algorithms including but not limited to Des and Triple Des, which are well known in the field of cryptography. The cryptographic key is then encrypted with another key, the encrypting key. This key is preferably a pre-shared private key. The method of encrypting the cryptographic key with the pre-shared key is similar to that of encrypting text or data with a pre-shared key, which is well known in the art.

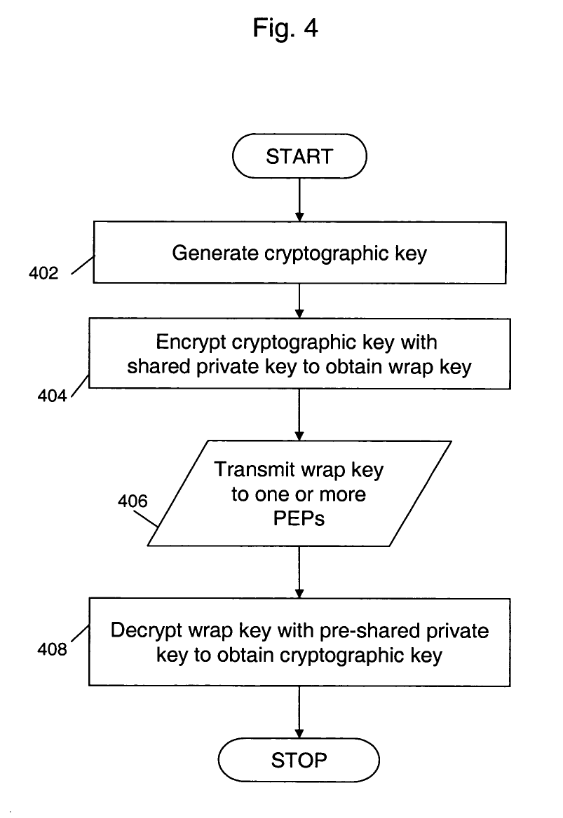

FIG. 4 is a flowchart depicting the method of generating a key and sending the key to policy enforcement points, in accordance with an embodiment of the present invention. The step of generating cryptographic key is depicted as 402 and the step of generating a wrap key is depicted as 404. The wrap key is then transmitted to PEPs at step 406. This is carried out by KAP 106. KAP 106 maintains a list of PEPs that it is responsible for generating keys. KAP 106 sends the wrap key to these PEPs. Once the PEPs receive the key, they use the pre-shared private key to decrypt the wrap key to obtain the cryptographic key, at step 408.

The generation of the cryptographic key, encrypting the cryptographic key with a pre-shared private key and storing the keys is all handled by the secure hardware module, 202. This prevents access to the keys. Thus, anyone who has physical access to KAP 106 cannot view the keys by electronically examining its memory, because the keys, except the wrap key, are not available on KAP 106. These keys are protected in the secure hardware module. Hence, these keys are not exposed in the memory or storage, or in plaintext where they can be easily viewed or accessed in KAP 106. The functions of protecting the cryptographic keys are carried out by the key protection module 310. It constantly monitors the secure hardware module 202 for attacks and shuts down the module 101 when such an attack is detected.

The attacks can either be physical, such as trying to electronically gain access to the secure hardware module to view the keys. They can also be in the form of software attacks, such as those by hackers. These attacks are also detected and the secure hardware module 202 is shut down so that the keys stored inside the module cannot be accessed.

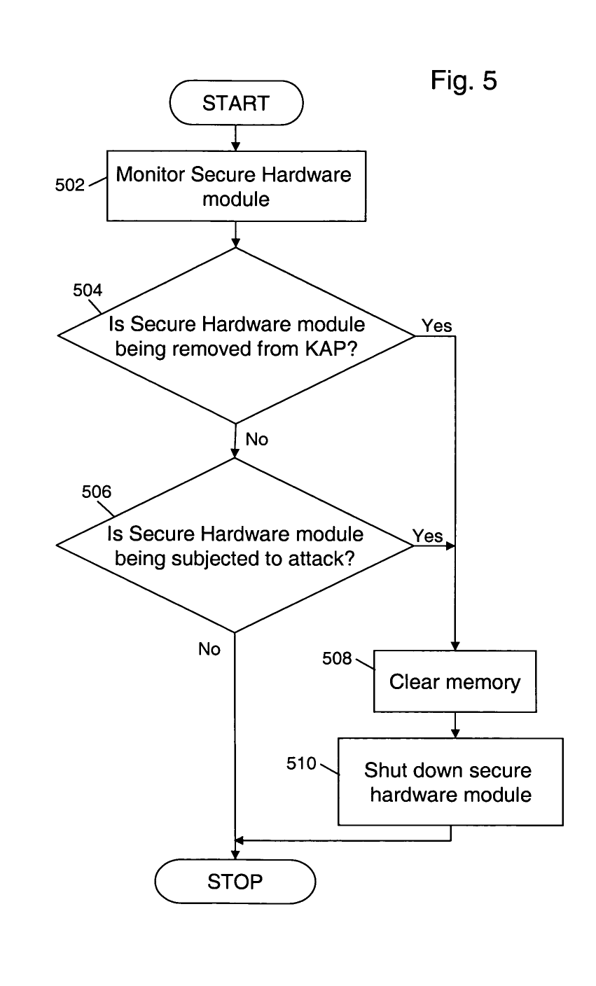

FIG. 5 is a flowchart depicting the method of protecting the secure hardware module, in accordance with an embodiment of the present invention. The key protection module 310 monitors the secure hardware module 202, at step 502. Key protections module 310 checks if secure hardware module 202 is being physically removed from KAP 106, at step 504. If it detects that secure hardware module 202 is being removed, or has been removed, then it clears memory 304 at step 508. Next, the secure hardware module 202 is shut down at step 510. In case key protection module 310 does not detect removal of secure hardware module 202 from KAP 106, it checks if it secure hardware module 202 is subject to attack, at step 506. In case it detects that secure hardware module 202 is under attack then steps 508 and 510 are carried out. In case secure hardware module 202 is not under attack, steps 502, 504 and 506 are repeated continuously.

Key protection module is able to detect attacks and intrusions directed towards stealing the cryptographic key. Since the cryptographic key is never exposed in KAP 106, it is always protected from attacks. In this way, cryptographic key is protected and at the same time distributed among the different KEPs 110, 112, 114 and 116.

Certain modifications and improvements will occur to those skilled in the art upon a reading of the foregoing description. By way of example, the number of KEPs may vary from one to infinity. The arrangement of the KEPs can also be varied to form different network topologies such as ring, mesh, point to point, and others. The method of encrypting the cryptographic key may be varied and is not limited to using a pre-shared private key. Also, the arrangement of the secure hardware module can be varied without affecting the scope of the invention. The above mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the following claims.

What is claimed is:

1. A method for enabling secure communication between a first node in a distributed network and at least one second node in the distributed network by using a cryptographic key, the method comprising the steps of:
a. Using an encrypting key to encrypt the cryptographic key to generate a wrap key in a secure hardware module;
b. Transmitting the wrap key to the at least one second node over a network; and
c. Decrypting the wrap key using the encrypting key to obtain the cryptographic key.

2. The method of claim 1, wherein the cryptographic key is generated by the secure hardware module.

3. The method of claim 1, wherein the first node is key authority point.

4. The method of claim 1, wherein the encrypting key is a pre-shared key.

5. The method of claim 1, wherein the second node is a policy enforcement point.

6. The method of claim 5, wherein the cryptographic key is used to negotiate a secure connection between the policy enforcement point and a second policy enforcement point.

7. The method of claim 6, wherein the negotiation is based on the Internet Key Exchange (IKE) protocol.

8. The method of claim 1, further comprising the step of storing the cryptographic key in the secure hardware module.

9. The method of claim 8, further comprising the step of disabling the secure hardware module if it is tampered.

10. A system for enabling secure communication in a distributed network by using a cryptographic key, the system comprising:
a. a first node transmitting the cryptographic key;
b. a secure hardware module for encrypting the cryptographic key with a encrypting key to obtain a wrap key;
c. a network for transmitting the wrap key; and
d. a second node, the second node configured to decrypt the wrap key using the encrypting key to obtain the cryptographic key.

11. The system of claim 10, wherein the encrypting key is a pre-shared private key.

12. The system of claim 10, wherein the secure hardware module generates the cryptographic key.

13. The system of claim 10, wherein the first node is a key authority point.

14. The system of claim 10, wherein the second node is a policy enforcement point.

15. The system of claim 14, further comprising at least another policy enforcement point.

16. The system of claim 10, wherein the cryptographic key enables Internet Key Exchange (IKE) protocol based negotiation between the first node and the second node.

17. The system of claim 10, wherein the secure hardware module stores the cryptographic key.

18. The system of claim 10, wherein the secure hardware module is disabled when tampered.

19. A secure hardware module for enabling secure communication in a distributed network using a cryptographic key, the secure hardware module comprising:
a. a cryptographic key generation module for generating a cryptographic key;
b. a wrap key generation module for encrypting the cryptographic key with a encrypting key to obtain a wrap key;
c. a storage module for storing the cryptographic key; and
d. a key protection module for protecting the cryptographic key from being accessed and for disabling the secure hardware module when tampered.

20. The secure hardware module of claim 19, wherein the secure hardware module generates the wrap key for a key authority point.

21. The secure hardware module of claim 19, wherein the wrap key is transmitted to at least one policy enforcement point.

22. The secure hardware module of claim 19, wherein the encrypting key is a pre-shared private key.
